(19) United States
(12) Patent Application Publication
(10) Pub. No.: US 2026/0067616 A1
(43) Pub. Date: Mar. 5, 2026

(54) AUDIO PROCESSING METHOD AND DEVICE

(71) Applicant: Lenovo (Beijing) Limited, Beijing (CN)

(72) Inventors: Hongzhou HUANG, Beijing (CN); Rongbin XIAO, Beijing (CN)

(21) Appl. No.: 19/311,467

(22) Filed: Aug. 27, 2025

(30) Foreign Application Priority Data
Aug. 29, 2024 (CN) 202411201439.0

(51) Int. Cl. H04R 3/00

(52) U.S. Cl. CPC H04R 3/00; H04R 2430/01

(57) ABSTRACT

An audio processing method includes: obtaining a first sound signal by an audio acquisition component; transforming the first sound signal into a first electrical signal; amplifying the first electrical signal into a second electrical signal according to a first gain value corresponding to the audio acquisition component; and processing the second electrical signal by a target model to obtain an output electrical signal, wherein the output electrical signal includes a third electrical signal, the third electrical signal differs from the first electrical signal by a second gain value, and the second gain value is less than the first gain value.

### RELATED APPLICATION(S)

This application claims priority to Chinese Patent Application No. 2024112014390 filed with the China National Intellectual Property Administration, on Aug. 29, 2024, which is incorporated herein by reference in entirety.

### FIELD OF THE TECHNOLOGY

The present disclosure relates to a field of audio technology, and in particular to an audio processing method and device.

### BACKGROUND

During a recording process, due to certain performance limitations of a recording equipment, when the input volume is high, the electrical signal amplitude of the sound after the recording equipment is amplified may exceed the amplitude upper limit of the recording equipment. The part of the electrical signal that exceeds the upper limit may be deleted, resulting in the loss of audio data obtained based on the electrical signal transformation, causing the collected audio data to be distorted.

### SUMMARY

In one aspect, the present disclosure provides an audio processing method. The method includes: obtaining a first sound signal by an audio acquisition component; transforming the first sound signal into a first electrical signal; amplifying the first electrical signal into a second electrical signal according to a first gain value corresponding to the audio acquisition component; and processing the second electrical signal by a target model to obtain an output electrical signal, wherein the output electrical signal includes a third electrical signal, the third electrical signal differs from the first electrical signal by a second gain value, and the second gain value is less than the first gain value.

In another aspect, the present disclosure provides an electronic device. The device includes: a memory storing computer program instructions; and a processor coupled to the memory and configured to execute the computer program instructions and perform: obtaining a first sound signal by an audio acquisition component; transforming the first sound signal into a first electrical signal; amplifying the first electrical signal into a second electrical signal according to a first gain value corresponding to the audio acquisition component; and processing the second electrical signal by a target model to obtain an output electrical signal, wherein the output electrical signal includes a third electrical signal, the third electrical signal differs from the first electrical signal by a second gain value, and the second gain value is less than the first gain value.

In yet another aspect, the present disclosure provides a non-transitory computer-readable storage medium storing computer program instructions executable by at least one processor to perform: obtaining a first sound signal by an audio acquisition component; transforming the first sound signal into a first electrical signal; amplifying the first electrical signal into a second electrical signal according to a first gain value corresponding to the audio acquisition component; and processing the second electrical signal by a target model to obtain an output electrical signal, wherein the output electrical signal includes a third electrical signal, the third electrical signal differs from the first electrical signal by a second gain value, and the second gain value is less than the first gain value.

### BRIEF DESCRIPTION OF THE DRAWINGS

To more clearly illustrate the technical solutions in certain embodiments of the present disclosure, the following briefly describes the figures used in the embodiments. The figures described below represent only certain embodiments of the present disclosure. Without inventive effort, other figures may be derived from the figures described.

FIG. 1 is a flow chart of an audio processing method according to certain embodiments of the present disclosure;

FIG. 2 is a schematic diagram of a signal according to certain embodiments of the present disclosure;

FIG. 3 is a schematic diagram of electrical signal input and output by a target model according to certain embodiments of the present disclosure;

FIG. 4 is a schematic diagram of electrical signal input and output by a target model according to certain embodiments of the present disclosure;

FIG. 5 is a schematic diagram of time domain and frequency domain characteristics of an electrical signal according to certain embodiments of the present disclosure; and

FIG. 6 is a schematic diagram of the structure of an audio processing device according to certain embodiments of the present disclosure.

### DETAILED DESCRIPTION

The following provides a description of the technical solutions in certain embodiments of the present disclosure, in conjunction with the accompanying drawings. The embodiments described reflect some of the embodiments of the present disclosure, and not necessarily all of the embodiments. Other embodiments derived without inventive effort are within the scope of protection of the present disclosure.

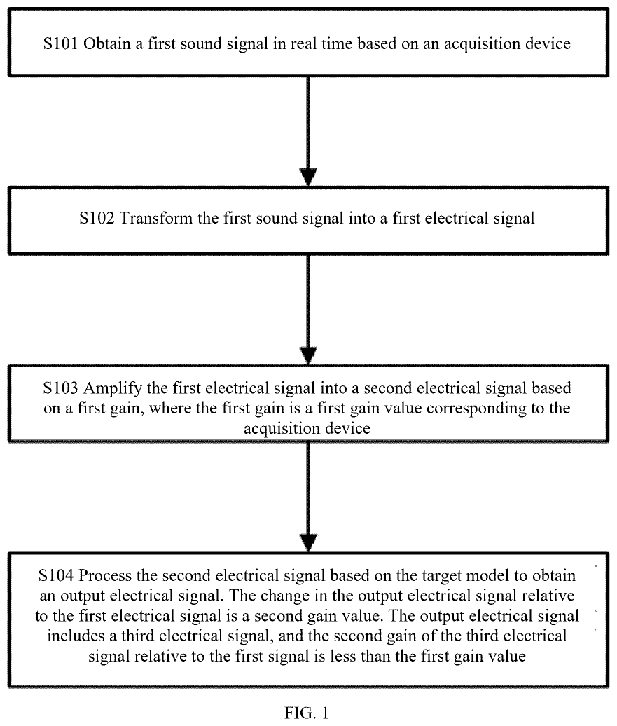

The present disclosure provides an audio processing method, as shown in FIG. 1. The method may include the following steps:

S101: Obtain a first sound signal in real time based on an acquisition device.

The acquisition device may be any recording device, such as a microphone.

After being activated, the acquisition device may collect multiple temporally continuous first sound signals generated by a sound source in the surrounding environment in real time. Each first sound signal may include sound collected by the acquisition device within a certain time period.

For example, a first sound signal may include sound collected by the acquisition device within 10 milliseconds (ms). Accordingly, obtaining a first sound signal in real time based on the acquisition device is equivalent to the acquisition device collecting sound from the sound source in real time, with each 10 ms of sound being considered as a first sound signal.

S102: Transform the first sound signal into a first electrical signal.

The acquisition device may include a sensor capable of transforming sound signals into electrical signals. The diaphragm of the sensor may vibrate in response to the first sound signal. As the diaphragm vibrates, the sensor may output a continuously changing electrical parameter representing the sound intensity at the corresponding moment. These continuously changing electrical parameters form a first electrical signal corresponding to the first sound signal.

Each first sound signal may be transformed into a first electrical signal of corresponding duration. For example, when each first sound signal includes sound collected by the acquisition device within 10 ms, the first electrical signal transformed from each first sound signal may include an electrical parameter representing the sound intensity within the corresponding 10 ms.

The acquisition device may transform each first sound signal into the first electrical signal in real time. For example, the acquisition device may acquire a first sound signal every 10 ms and transform each acquired first sound signal into a corresponding first electrical signal, thereby obtaining multiple continuous first electrical signals.

S103: Amplify the first electrical signal into a second electrical signal based on a first gain, where the first gain is a first gain value corresponding to the acquisition device.

The first gain may be the analog gain of the acquisition device. The acquisition device may amplify each transformed first electrical signal in real time based on the set analog gain, thereby transforming the multiple temporally consecutive first electrical signals obtained in step S102 into multiple temporally consecutive amplified second electrical signals.

For the same first electrical signal, the larger the analog gain value (for example, the first gain value), the greater the signal amplitude of the amplified second electrical signal.

The first gain value of the acquisition device may be pre-set by the user of the acquisition device. For example, the acquisition device may include components for setting the analog gain, which the user may manipulate to increase or decrease the first gain value of the acquisition device.

Generally, when executing S103, the first gain value may be a fixed gain value.

S104: Process the second electrical signal based on the target model to obtain an output electrical signal. The change in the output electrical signal relative to the first electrical signal is a second gain value. The output electrical signal includes a third electrical signal, and the second gain of the third electrical signal relative to the first signal is less than the first gain value.

Each time the acquisition device obtains a second electrical signal by transformation, the acquisition device inputs the second electrical signal into the target model. For each second electrical signal, the target model may output an output electrical signal corresponding to the second electrical signal, thereby processing the multiple consecutive second electrical signals transformed in S103 into multiple consecutive output electrical signals.

Each output electrical signal corresponds to a first electrical signal. For example, after obtaining the i-th first electrical signal, the acquisition device amplifies the i-th first electrical signal according to the first gain value to produce the i-th second electrical signal, and then processes the i-th second electrical signal using the target model to produce the i-th third electrical signal. In certain embodiments, the i-th third electrical signal corresponds to the i-th first electrical signal, where i is any positive integer.

The output electrical signal may be considered as an electrical signal obtained by amplifying the corresponding first electrical signal based on the second gain value.

Different output electrical signals may correspond to different second gain values. Some output electrical signals may have a second gain value with respect to the corresponding first electrical signal that is smaller than the first gain value in S103. Such output electrical signals are the aforementioned third electrical signals.

The target model may determine how to process each of the multiple consecutive second electrical signals input, that is, determine which second electrical signals should be processed into third electrical signals.

The target model may be a pre-built neural network model for processing electrical signals transformed from sound signals.

The beneficial effects of certain embodiments are:

In related art, some solutions may set a low analog gain value for the acquisition device to ensure that the amplified electrical signal does not exceed the upper limit of the acquisition device's amplitude. The digital gain processing is then performed on the audio data obtained by transforming the electrical signal through digital gain. This approach limits the performance of the acquisition device and increases noise in the audio data. Compared to related art solutions, the present disclosure in certain embodiments may directly adjust the analog gain value of a portion of the amplified electrical signal through a target model. This processing method allows electrical signals that do not exceed the acquisition device's upper limit after amplification to have a larger analog gain value (for example, the first gain value), thereby maximizing the performance of the acquisition device and reducing noise in the audio data. Furthermore, by reducing the gain of the output electrical signal relative to the first electrical signal, the amplitude of the amplified electrical signal that exceeds the upper limit is adjusted to below the upper limit, thereby preventing the portion of the electrical signal that exceeds the upper limit from being directly deleted and causing distortion in the corresponding audio data. Thus, this solution according to certain embodiments of the present disclosure may fully utilize the performance of the acquisition device while at least partially solving the problem of distortion caused by excessive signal amplitude in the recorded electrical signal.

In order to obtain multiple output electrical signals with good continuity, the second electrical signal may be processed as follows:
Obtain multiple temporally continuous second electrical signals;
Process the multiple second electrical signals based on the target model to obtain multiple output electrical signals, where the i−1th, i-th, and i+1th of the multiple output electrical signals are three temporally continuous third electrical signals;
The second gain of the i-th third electrical signal relative to the first electrical signal is greater than the second gain of the i−1th third electrical signal relative to the first electrical signal;
The second gain of the i-th third electrical signal relative to the first electrical signal is greater than the second gain of the i+1th third electrical signal relative to the first electrical signal.

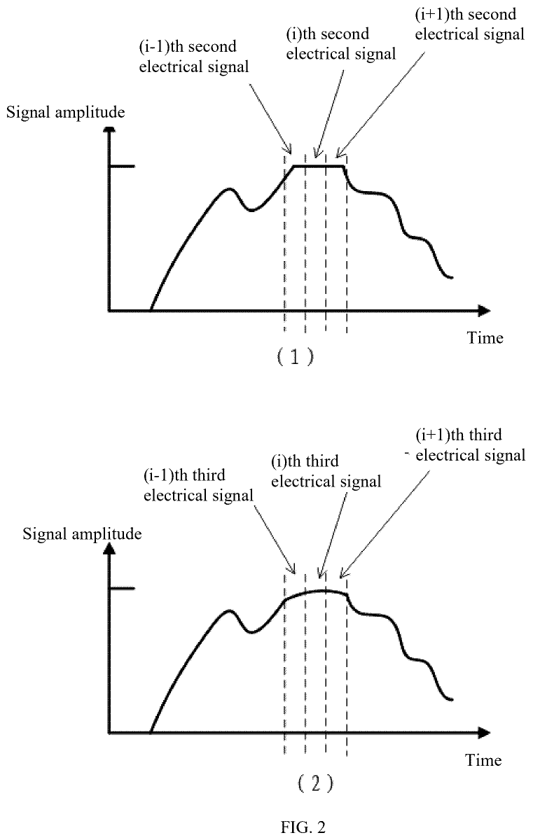

That is, when processing multiple continuous second electrical signals, the target model may process at least three continuous second electrical signals into at least three continuous third electrical signals. For example, in FIG. 2, the i−1th second electrical signal, the i-th second electrical signal, and the i+1th second electrical signal shown in (1) of FIG. 2 are processed into the i−1th third electrical signal, the i-th third electrical signal, and the i+1th third electrical signal shown in (2) of FIG. 2, respectively.

The second gain value corresponding to the i-th third electrical signal is greater than the second gain value corresponding to the i−1-th third electrical signal, and greater than the second gain value corresponding to the i+1-th third electrical signal. In this manner, the target model may control the amplitude corresponding to the i-th third electrical signal to be greater than the amplitude corresponding to the i−1-th third electrical signal, and greater than the amplitude corresponding to the i+1-th third electrical signal. This allows three consecutive third electrical signals to more closely resemble the true variation pattern of the sound signal, thereby reducing the distortion of the collected audio.

In certain embodiments, among the multiple output electrical signals obtained by the target model, some of the output electrical signals may be fourth electrical signals, where the second gain of the fourth electrical signal relative to the first electrical signal is equal to the first gain value.

For example, the acquisition device amplifies a first electrical signal to a second electrical signal according to a first gain value of 5 dB. The target model processes the second electrical signal and outputs a corresponding fourth electrical signal, where the second gain of the fourth electrical signal relative to the first signal is still 5 dB.

The fourth electrical signal may be obtained by, after the target model obtains a second electrical signal, when it is determined that the second electrical signal does not need to be processed into a third electrical signal, the second electrical signal may be directly output as the corresponding fourth electrical signal, thereby obtaining a fourth electrical signal having the same second gain value as the first gain value.

In certain embodiments, after obtaining the i-th second electrical signal, the target model determines whether to process the i-th second electrical signal into a third electrical signal. When the i-th second electrical signal does not need to be processed into a third electrical signal, the i-th second electrical signal is output as a fourth electrical signal. When the i-th second electrical signal needs to be processed into a third electrical signal, the gain of the i-th second electrical signal relative to the corresponding i-th first electrical signal is adjusted, and a third electrical signal obtained by the adjustment is output, where the second gain value is less than the first gain value.

The target model may determine which second electrical signals to output as the fourth electrical signal based on multiple consecutive second electrical signals input.

Methods for obtaining the third electrical signal based on processing according to the target model may include:
Processing N consecutive second electrical signals in time according to the target model to determine that the N+1th second electrical signal meets the target condition;
Processing the N+1th second electrical signal according to the target model to obtain the third electrical signal.

N may be a preset integer, and its value may be set as needed. If the target model may need to have a higher processing efficiency, a smaller N may be set. If the accuracy of the processing result of the target model may need to be improved, a larger N may be output. For example, N may be set to 5, 8 or other integers.

After the acquisition device begins to output the second electrical signal, each second electrical signal output by the acquisition device may be input into the target model in real time. Each time a second electrical signal is input, the target model may process the second electrical signal and output a corresponding output electrical signal.

Before the cumulative number of second electrical signals input into the target model reaches N, the target model may process the second electrical signals in the following manner:
directly outputting the second electrical signal as the output electrical signal. In certain embodiments, the output electrical signal obtained is equivalent to the aforementioned fourth electrical signal.

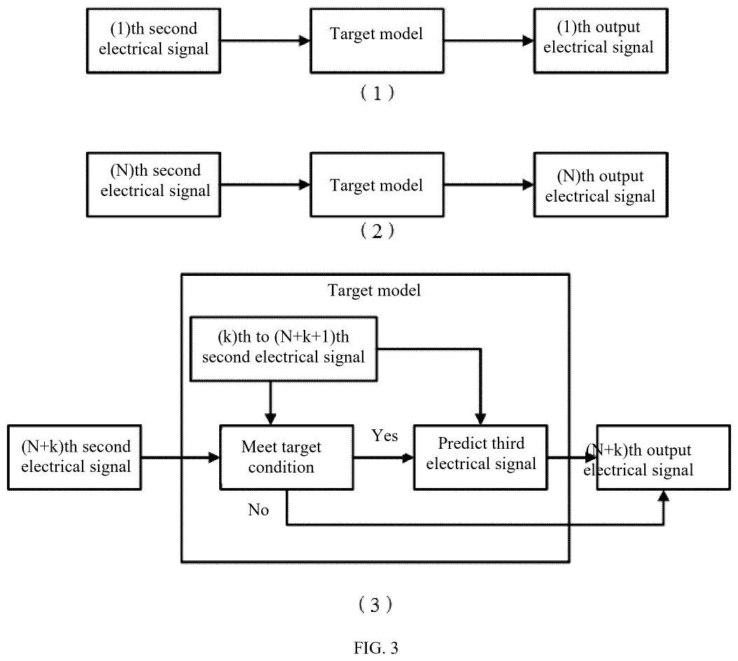

As shown in (1) and (2) of FIG. 3, before the Nth second electrical signal is input into the target model, the target model may determine the first to Nth second electrical signals as output electrical signals and directly output the first to Nth output electrical signals.

After the cumulative number of second electrical signals input into the target model reaches N, starting from the N+1th second signal input into the target model, each time a second electrical signal is input, the target model may determine whether the second electrical signal meets the target condition based on the N second electrical signals before the second electrical signal; when the second electrical signal meets the target condition, the target model may predict the processing result corresponding to the second electrical signal based on the second electrical signal and the previous N second electrical signals, that is, predict what kind of third electrical signal the second electrical signal will be processed into, and then output the predicted processing result as the output electrical signal.

As shown in (3) of FIG. 3, after receiving N second electrical signals cumulatively, when the N+kth second electrical signal is received, the target model determines whether the N+kth second electrical signal meets the target condition based on the kth to N+k−1th second electrical signals. After determining that the N+kth second electrical signal meets the target condition, the target model predicts the corresponding processing result based on the kth to N+k−1th second electrical signals, that is, predicts the third electrical signal obtained after processing the N+kth second electrical signal, and outputs the predicted third electrical signal as the N+kth output electrical signal. k may be greater than or equal to 1.

The beneficial effects of certain embodiments are:

For the N+1th and subsequent second electrical signals, the target model may determine whether to process the second electrical signal into the third electrical signal based on the N second electrical signals before the second electrical signal, and determine the third electrical signal obtained after processing the second electrical signal based on the second electrical signal and the previous N second electrical signals. This may improve the accuracy of the processing result of the target model, so that the output of the continuous multiple output electrical signals is more consistent with the real first sound signal.

In certain embodiments, processing N temporally consecutive second electrical signals based on the target model to determine that the (N+1)th second electrical signal meets the target condition may include:

N temporally consecutive second electrical signals are processed based on the target model to determine whether the signal amplitude of the N+1th second electrical signal exceeds the upper signal amplitude limit of the acquisition device.

Similarly, for any N+kth second electrical signal, the N temporally consecutive second electrical signals preceding that second electrical signal, for example, the kth to N+k−1th second electrical signals, may be processed based on the target model to determine whether the signal amplitude of the N+kth second electrical signal exceeds the upper signal amplitude limit of the acquisition device. If so, the N+kth second electrical signal is determined to meet the target condition; if not, the N+kth second electrical signal is determined to not meet the target condition.

That is, in certain embodiments, the target condition may include the signal amplitude corresponding to the second electrical signal being greater than the upper signal amplitude limit of the acquisition device.

Due to the hardware performance limitations of the acquisition device, there is an upper limit on the signal amplitude that the acquisition device may output. When the amplitude of an electrical signal exceeds this upper limit, the acquisition device will directly filter out the signal exceeding the upper signal amplitude limit when outputting the electrical signal, ultimately outputting an electrical signal with an amplitude that meets the upper limit of the device.

When the signal amplitude of a second electrical signal output by the acquisition device reaches the upper limit of the acquisition device, the signal amplitude of the second electrical signal may be exactly equal to the upper limit of the acquisition device, or the signal amplitude of the electrical signal obtained after amplification by the first gain value may exceed the upper limit of the acquisition device, causing the acquisition device to filter out the portion of the electrical signal that exceeds the upper limit and output only the electrical signal with an amplitude that reaches the upper limit of the device.

Therefore, for the N+kth second electrical signal input to the target model, when the signal amplitude of the second electrical signal reaches the upper limit of the acquisition device, the target model may predict the signal amplitude of the second electrical signal without filtering by the acquisition device based on the time domain variation patterns of the N consecutive second electrical signals preceding the second electrical signal. Based on the signal amplitude of the second electrical signal, the target model may determine whether the second electrical signal meets the target condition.

In certain embodiments, the target condition may include:

The signal amplitude of the second electrical signal exceeds the upper limit of the acquisition device's signal amplitude, or the second electrical signal is one of the M second electrical signals before or after the second electrical signal whose signal amplitude exceeds the upper limit of the acquisition device's signal amplitude.

The second electrical signal whose signal amplitude is greater than the signal amplitude upper limit of the acquisition device, and the first M second electrical signals and the last M second electrical signals of the second electrical signal whose signal amplitude is greater than the signal amplitude upper limit of the acquisition device may be processed into a third electrical signal based on the target model.

M may be a fixed value, such as 5, 10, or another integer, or a dynamic value determined based on the target model.

In certain embodiments, when the target model determines that the signal amplitude of the N+1th second electrical signal is greater than the upper limit of the acquisition device, the N+1th second electrical signal may be processed based on the target model to output a corresponding third electrical signal. In certain embodiments, the following methods may be used:
Multiple second electrical signals preceding the N+1th second electrical signal may be processed based on the target model to obtain multiple third electrical signals;
Multiple second electrical signals following the N+1th second electrical signal may be processed based on the target model to obtain multiple third electrical signals.

For any N+kth second electrical signal, when the target model determines that the signal amplitude of the N+kth second electrical signal is greater than the upper limit of the acquisition device, the N+kth second electrical signal, the M second electrical signals preceding the N+kth second electrical signal, and the M second electrical signals following the N+kth second electrical signal may be processed to obtain multiple corresponding third electrical signals.

The beneficial effects of certain embodiments are:

Not only is the gain of the second electrical signal whose signal amplitude is greater than the upper limit of the acquisition device adjusted, but the gain of multiple second electrical signals before and after it is also adjusted. This allows the signal envelopes of the multiple consecutive third electrical signals obtained after adjustment to be closer to the signal envelope of the first electrical signal, thereby reducing the distortion of the third electrical signals and making the third electrical signals more realistically reflect the collected sound.

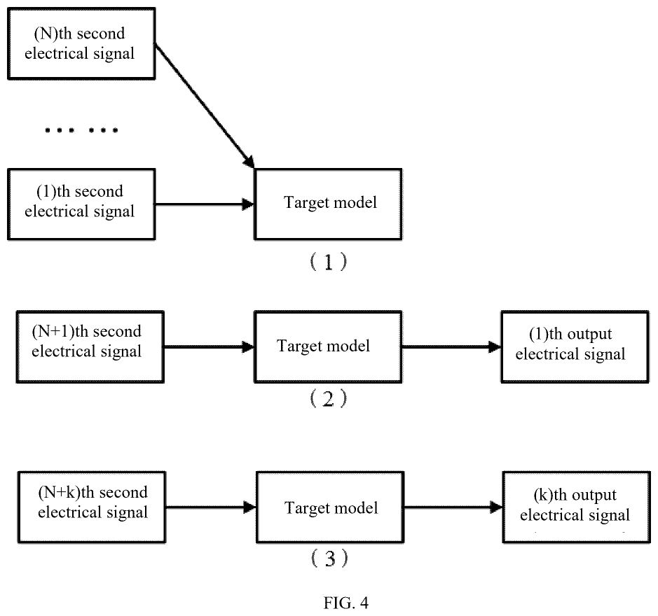

In certain embodiments, as shown in (1) of FIG. 4, the target model may not output the output electrical signal before the number of second electrical signals input to the target model reaches N+1.

As shown in (2) of FIG. 4, starting from the input of the N+1th second electrical signal into the target model, the target model predicts whether the N+1th second electrical signal meets the target condition based on the first N second electrical signals, and in this way predicts whether each second electrical signal after the N+1th second electrical signal meets the target condition. On the other hand, the target model may process each second electrical signal one by one starting from the first input second electrical signal, and output the output electrical signal corresponding to each second electrical signal (which may be the third electrical signal or the fourth electrical signal). That is, as shown in (3) of FIG. 4, the output electrical signal output by the target model may be delayed by N electrical signals compared to the second electrical signal input into the target model, that is, when the N+1th second electrical signal is input, the target model outputs the first output electrical signal, when the N+2th second electrical signal is input, the target model outputs the second output electrical signal, and when the N+kth second electrical signal is input, the target model outputs the kth output electrical signal.

In certain embodiments, when processing the (N+1)th second electrical signal based on the target model to obtain the third electrical signal, the (N+1)th second electrical signal may be processed in combination with multiple second electrical signals preceding and following the (N+1)th second electrical signal. That is, the method for processing the (N+1)th second electrical signal to obtain the third electrical signal may be:

Processing the (N+1)th second electrical signal based on the target model and multiple second electrical signals preceding and following the (N+1)th second electrical signal to obtain the third electrical signal.

The target model may process the (N+1)th second electrical signal based on the S second electrical signals preceding and S second electrical signals following the (N+1)th second electrical signal to obtain the corresponding third electrical signal.

In certain embodiments, for any (N+k)th second electrical signal, when the (N+k)th second electrical signal meets the target condition, the target model may also process the (N+k)th second electrical signal based on the S second electrical signals preceding and S second electrical signals following the (N+k)th second electrical signal to obtain the corresponding third electrical signal.

S is a preset positive integer, which may or may not be equal to N.

When processing the N+1th second electrical signal that meets the target condition, the target model may predict the third electrical signal corresponding to the N+1th second electrical signal based on the S second electrical signals preceding and S second electrical signals following the N+1th second electrical signal, and then output the predicted electrical signal as the third electrical signal corresponding to the N+1th second electrical signal. The processing method for the N+kth second electrical signal is similar and description is not repeated for brevity.

In certain embodiments, for any second electrical signal that meets the target condition, the method for predicting the third electrical signal corresponding to the second electrical signal based on the target model may be:

First, process each second electrical signal for prediction using a suitable algorithm for extracting time domain and frequency domain features of electrical signals to obtain time domain and frequency domain features of the second electrical signals.

For example, when the third electrical signal corresponding to the (N+1)th second electrical signal is to be predicted based on the first N second electrical signals, the time domain features and frequency domain features of the first N second electrical signals may be extracted, resulting in N time domain features and N frequency domain features.

When the third electrical signal corresponding to the (N+1)th second electrical signal is to be predicted based on the first S electrical signals and the last S second electrical signals of the (N+1)th second electrical signal, the time domain features and frequency domain features of the first S second electrical signals may be extracted, and the time domain features and frequency domain features of the last S second electrical signals may be extracted, resulting in 2S time domain features and 2S frequency domain features.

The time domain and frequency domain features are input into the target model for processing. The target model predicts the time domain and frequency domain features of the third electrical signal based on these input time domain and frequency domain features.

The time domain and frequency domain features of the third electrical signal output by the target model may be restored using any suitable algorithm for restoring the corresponding signal based on signal features, thereby obtaining the third electrical signal predicted by the target model.

In certain embodiments, the target model may predict the time domain and frequency domain features of the third electrical signal corresponding to the (N+1)th second electrical signal to be processed based on the time domain and frequency domain features of the first N second electrical signals. The predicted time domain and frequency domain features may then be restored to obtain the third electrical signal corresponding to the (N+1)th second electrical signal.

Method of processing the (N+1)th second electrical signal may be applied to processing of any (N+k)th second electrical signal that meets the target conditions and the description of which is not repeated for brevity.

The beneficial effects of certain embodiments are as follows:

When processing the N+kth second electrical signal, the target model may obtain the signal amplitudes of the preceding and succeeding second electrical signals based on their time domain features, understand the semantics represented by the consecutive second electrical signals based on their frequency domain features, and predict the variation pattern of the signal amplitudes of the second electrical signals based on the semantics. The target model may combine the signal amplitudes of the preceding and succeeding second electrical signals with the variation pattern of the signal amplitudes of the consecutive second electrical signals to more accurately predict the third electrical signal.

In certain embodiments, the target model may combine the first N second electrical signals to determine whether the N+1th second electrical signal meets the target condition in the following manner:
Extract the time domain features and frequency domain features of the N second electrical signals that are continuous in time;
Process the time domain features and frequency domain features of the N second electrical signals based on the target model to determine whether the N+1th second electrical signal meets the target condition.

For any N+kth second electrical signal, the target model may determine whether the N+1th second electrical signal meets the target condition based on the N second electrical signals before the N+kth second electrical signal in the above manner.

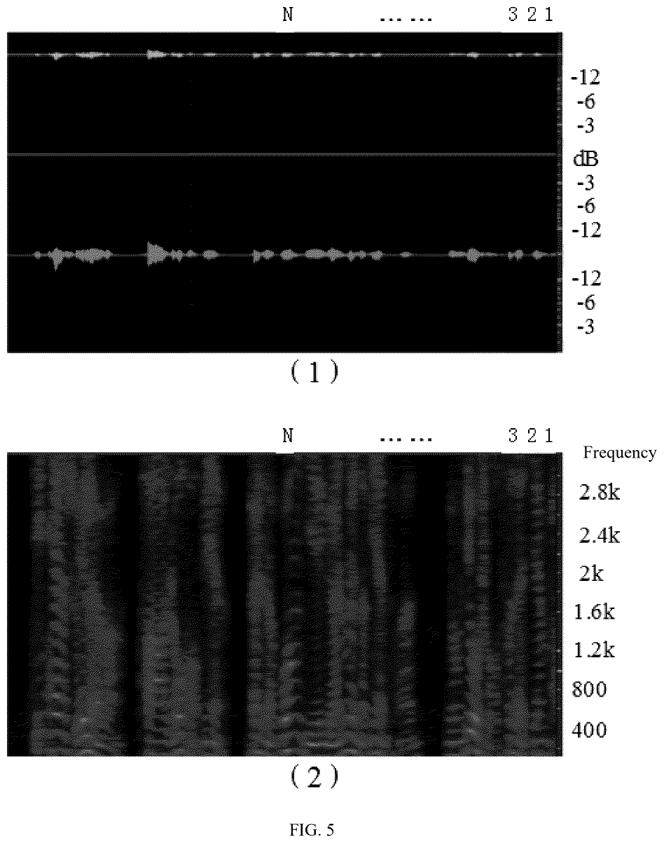

In certain embodiments, the time domain features of the N second electrical signals that are continuous in time may be as shown in (1) of FIG. 5, and the frequency domain features of these N second electrical signals may be as shown in (2) of FIG. 5, where the time domain features of the second electrical signal reflect the overall signal amplitude of the second electrical signal in the corresponding time period, and the frequency domain features of the second electrical signal reflect the strength of the signal components of the second electrical signal at each frequency.

In the figure, the horizontal axes 1 to N represent the first to Nth second electrical signals.

It may be seen that due to the different semantics represented by different sound signals, the tones of different sound signals are different, and the difference in tone may be reflected in the frequency domain characteristics of the corresponding electrical signal. For example, for a sound signal with a higher pitch, the high-frequency signal component of the corresponding second electrical signal is stronger, and the low-frequency signal component is weaker. For a sound signal with a lower pitch, the high-frequency signal component of the corresponding second electrical signal is weaker, and the low-frequency signal component is stronger.

In certain embodiments, after obtaining the frequency domain features of the N second electrical signals, the target model may understand the semantics of the sound signals corresponding to the N second electrical signals based on these frequency domain features, and infer the semantics of the sound signal corresponding to the N+1th second electrical signal based on the semantics of the N second electrical signals. Based on the time domain features of the first N second electrical signals, the target model may understand the temporal variation of the signal amplitude of the second electrical signals.

Thus, the target model may combine the semantics corresponding to the N+1th second electrical signal and the variation pattern of the signal amplitude of the second electrical signal to determine the actual signal amplitude of the N+1th second electrical signal, thereby determining whether the signal amplitude of the N+1th second electrical signal exceeds the upper limit of the signal amplitude of the acquisition device.

When determining that the N+1th second electrical signal needs to be processed into a third electrical signal, the target model may predict the frequency domain features of the processed third electrical signal based on the inferred semantics corresponding to the N+1th second electrical signal, predict the time domain features of the processed third electrical signal based on the variation pattern of the signal amplitude, and finally generate the processed third electrical signal by combining the frequency domain features and the time domain features.

The beneficial effect of this embodiment is that, based on the time domain and frequency domain features of the first N second electrical signals, the target model may determine the signal amplitudes of the first N second electrical signals and, based on the semantics represented by the consecutive second electrical signals, predict the variation pattern of the signal amplitudes of the second electrical signals. Thus, the target model may combine the signal amplitudes and variation patterns of the first N second electrical signals to more accurately determine whether the (N+1)th second electrical signal meets the target condition.

In certain embodiments, the target model may be constructed based on sample sound signals and target sound signals collected from the same sound source, where the sample sound signals are collected by an acquisition device and the target sound signal is collected by a target device different from the acquisition device.

Sample sound signals and target sound signals may be collected as follows:

A sound source device, a sound acquisition device, and a target device are separately placed, with the acquisition device and target device being placed in the same location. The acquisition device may be a low-precision sound acquisition device integrated into a terminal device (for example, a mobile phone), such as a mobile phone microphone. The target device may be a high-precision standard recording device, such as a standard microphone. The sound source device may be a speaker or other device capable of emitting sound into its surroundings.

After placing the above devices, the sound source device, acquisition device, and target device are activated, causing the sound source device to emit a sound signal. The acquisition device and target device simultaneously collect the sound signal generated by the sound source device. The sound signal obtained by the acquisition device may be used as the sample sound signal, and the sound signal obtained by the target device may be used as the target sound signal.

The sound signal emitted by the sound source device may be obtained as follows:

A user's speech is recorded to obtain a segment of the user's voice. This segment of voice is then subjected to random dynamic gain processing to simulate random fluctuations in the sound source volume. The resulting sound signal after random dynamic gain processing is used as the sound signal emitted by the sound source device.

The target model may be constructed based on the sample sound signal and the target sound signal as follows:
First, a randomly initialized neural network model is obtained as an initial model;
The target sound signal is transformed into a target electrical signal;
Based on the initial model, the sample sound signal is processed according to the method of the aforementioned embodiments to obtain a continuous output electrical signal;
The output electrical signal is compared with the target electrical signal, and the model loss of the initial model is determined. The model loss may be determined based on the Euclidean distance and similarity. The Euclidean distance may be the Euclidean distance between the frequency domain features of the output electrical signal and the frequency domain features of the target electrical signal, and the similarity may be the similarity between the time domain features of the output electrical signal and the time series features of the target electrical signal.

When the model loss does not meet the convergence condition, the model parameters of the initial model may be updated based on the model loss. After the update is complete, the process returns to the step of processing the sample sound signal according to the method of the aforementioned embodiment based on the initial model to obtain a continuous output electrical signal.

If the model loss meets the convergence condition, the initial model may be determined as the constructed target model.

The convergence condition may be that the model loss is less than or equal to a particular convergence threshold.

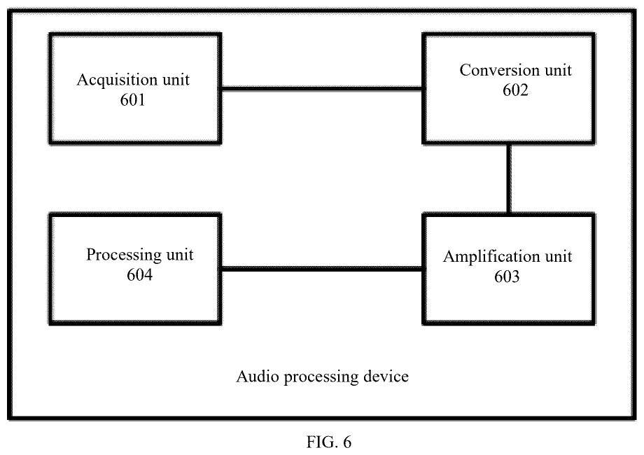

The present disclosure in certain embodiments provides an audio processing device. In this application, an audio processing device may refer to any electronic device that provides audio processing functions consistent with embodiments of the present disclosure. FIG. 6 is a schematic structural diagram of an audio processing device/electronic device. The device may include the following units:

An acquisition unit 601 is configured to acquire a first sound signal in real time based on an acquisition device.

A transformation unit 602 is configured to transform the first sound signal into a first electrical signal.

An amplification unit 603 is configured to amplify the first electrical signal into a second electrical signal based on a first gain, where the first gain is a first gain value corresponding to the acquisition device.

A processing unit 604 is configured to process the second electrical signal based on a target model to obtain an output electrical signal. The output electrical signal has a change relative to the first electrical signal of a second gain value. The output electrical signal includes a third electrical signal, where the second gain of the third electrical signal relative to the first electrical signal is less than the first gain value.

In certain embodiments, when processing the second electrical signal based on the target model to obtain an output electrical signal, processing unit 604 may be configured to: obtain multiple temporally consecutive second electrical signals;
process the multiple second electrical signals based on the target model to obtain multiple output electrical signals, where the (i−1)th, (i)th, and (i+1)th of the multiple output electrical signals are three temporally consecutive third electrical signals;
the second gain of the (i)th third electrical signal relative to the first electrical signal is greater than the second gain of the (i−1)th third electrical signal relative to the first signal;
The second gain of the i-th third electrical signal relative to the first electrical signal is greater than the second gain of the i+1-th third electrical signal relative to the first electrical signal.

In certain embodiments, the output electrical signal includes a fourth electrical signal, and the second gain of the fourth electrical signal relative to the first electrical signal is equal to the first gain value.

In certain embodiments, when processing the second electrical signal based on the target model to obtain the output electrical signal, the processing unit 604 may be used to:
Process N temporally consecutive second electrical signals based on the target model to determine that the (N+1)-th second electrical signal meets the target condition;
Process the (N+1)-th second electrical signal based on the target model to obtain the third electrical signal.

In certain embodiments, when processing N temporally consecutive second electrical signals based on the target model to determine that the (N+1)-th second electrical signal meets the target condition, the processing unit 604 may be used to:
Extract time domain features and frequency domain features of the N temporally consecutive second electrical signals;
Process the time domain and frequency domain features of N second electrical signals based on the target model to determine that the N+1th second electrical signal meets the target condition.

In certain embodiments, when processing the N+1th second electrical signal based on the target model to obtain a third electrical signal, the processing unit 604 may be configured to:

Process the N+1th second electrical signal based on the target model and multiple second electrical signals preceding and following the N+1th second electrical signal to obtain the third electrical signal.

In certain embodiments, the processing unit 604 may be configured to:
Process multiple second electrical signals preceding the N+1th second electrical signal based on the target model to obtain multiple third electrical signals;
Process multiple second electrical signals following the N+1th second electrical signal based on the target model to obtain multiple third electrical signals.

In certain embodiments, when processing N temporally consecutive second electrical signals based on the target model to determine that the N+1th second electrical signal meets the target condition, the processing unit 604 may be configured to:

Process the N temporally consecutive second electrical signals based on the target model to determine that the signal amplitude of the N+1th second electrical signal exceeds the upper limit of the signal amplitude of the acquisition device.

In certain embodiments, the target model is constructed based on sample sound signals and target sound signals collected from the same sound source, with the sample sound signals collected by an acquisition device and the target sound signals collected by a target device different from the acquisition device.

The operating principles of the audio processing device of certain embodiments may be found in the relevant steps of the audio processing method as provided and are not repeated for brevity.

Similar parts between the various embodiments may be referenced to each other. Each embodiment focuses on the differences from other embodiments. In particular, since the device embodiments are generally similar to the method embodiments, the description of the device embodiments is accordingly simplified. For relevant parts, reference may be made to the description of the method embodiments. The device embodiments described above are merely illustrative. The units described as separate components may or may not be physically separate, and the components shown as units may or may not be physical units; they may be located in one location or distributed across multiple network units. Some or all of these modules may be selected to achieve the objectives of the present embodiments. Modifications to the described embodiments may be implemented without inventive effort.

Elements and algorithmic steps of the various embodiments disclosed herein may be implemented using electronic hardware, computer software, or a combination of both.

To illustrate the interchangeability of hardware and software, components and steps are described by function. Whether these functions are implemented in hardware or software depends on the particular implementation and designs of the technical solution. Suitable modifications to these particular implementations and designs are within the scope of the present disclosure.

Certain embodiments have been described. Various modifications to these embodiments may be readily apparent, and the general principles may be implemented in other embodiments without departing from the spirit or scope of the present disclosure. The present disclosure is not limited to the embodiments shown herein, but is intended to have the widest scope consistent with the principles and novel features disclosed herein.

What is claimed is:

1. An audio processing method, comprising:
obtaining a first sound signal by an audio acquisition component;
transforming the first sound signal into a first electrical signal;
amplifying the first electrical signal into a second electrical signal according to a first gain value corresponding to the audio acquisition component; and
processing the second electrical signal by a target model to obtain an output electrical signal, wherein the output electrical signal includes a third electrical signal, the third electrical signal differs from the first electrical signal by a second gain value, and the second gain value is less than the first gain value.

2. The method of claim 1, wherein processing the second electrical signal includes:
obtaining a plurality of temporally consecutive second electrical signals;
processing the plurality of second electrical signals based on the target model to obtain a plurality of output electrical signals, wherein the (i−1), (i), and (i+1)-th output electrical signals are three temporally consecutive third electrical signals;
a second gain of the (i)-th third electrical signal relative to the first electrical signal is greater than a second gain of the (i−1)-th third electrical signal relative to the first electrical signal;
the second gain of the (i)-th third electrical signal relative to the first electrical signal is greater than a second gain of the (i+1)-th third electrical signal relative to the first electrical signal.

3. The method of claim 1, wherein the output electrical signal includes a fourth electrical signal, and a second gain value of the fourth electrical signal relative to the first electrical signal is equal to the first gain value.

4. The method of claim 1, wherein processing the second electrical signal includes:
processing N temporally consecutive second electrical signals based on the target model to determine whether the (N+1)th second electrical signal meets the target condition;
processing the (N+1)th second electrical signal based on the target model to obtain the third electrical signal.

5. The method of claim 4, wherein processing N temporally consecutive second electrical signals includes:
extracting time domain features and frequency domain features of the N temporally consecutive second electrical signals; and
processing the time domain features and frequency domain features of the N second electrical signals based on the target model to determine whether the (N+1)th second electrical signal meets the target condition.

6. The method of claim 4, wherein processing the (N+1)th second electrical signal includes:
processing the (N+1)th second electrical signal based on the target model and multiple second electrical signals preceding and following the (N+1)th second electrical signal to obtain the third electrical signal.

7. The method of claim 4, further comprising:
processing multiple second electrical signals before the (N+1)th second electrical signal based on the target model to obtain multiple third electrical signals; and
processing multiple second electrical signals after the (N+1)th second electrical signal based on the target model to obtain multiple third electrical signals.

8. The method of claim 4, wherein processing N temporally consecutive second electrical signals includes:
processing N temporally consecutive second electrical signals based on the target model to determine that signal amplitude of the (N+1)th second electrical signal is greater than an upper limit of the signal amplitude of the acquisition device.

9. The method of claim 1, wherein the target model is constructed based on a sample sound signal and a target sound signal collected from a same sound source, the sample sound signal is collected by the acquisition device, and the target sound signal is collected by a target device different from the acquisition device.

10. An electronic device, comprising: audio acquisition component, a memory storing computer program instructions; and a processor coupled to the memory and configured to execute the computer program instructions and perform:
obtaining a first sound signal by the audio acquisition component;
transforming the first sound signal into a first electrical signal;
amplifying the first electrical signal into a second electrical signal according to a first gain value corresponding to the audio acquisition component; and
processing the second electrical signal by a target model stored in the electronic device to obtain an output electrical signal, wherein the output electrical signal includes a third electrical signal, the third electrical signal differs from the first electrical signal by a second gain value, and the second gain value is less than the first gain value.

11. The electronic device of claim 10, wherein processing the second electrical signal includes:
obtaining a plurality of temporally consecutive second electrical signals;
processing the plurality of second electrical signals based on the target model to obtain a plurality of output electrical signals, wherein the (i−1), (i), and (i+1)-th output electrical signals are three temporally consecutive third electrical signals;
a second gain of the (i)-th third electrical signal relative to the first electrical signal is greater than a second gain of the (i−1)-th third electrical signal relative to the first electrical signal;
the second gain of the (i)-th third electrical signal relative to the first electrical signal is greater than a second gain of the (i+1)-th third electrical signal relative to the first electrical signal.

12. The electronic device of claim 10, wherein the output electrical signal includes a fourth electrical signal, and a second gain value of the fourth electrical signal relative to the first electrical signal is equal to the first gain value.

13. The electronic device of claim 10, wherein processing the second electrical signal includes:
processing N temporally consecutive second electrical signals based on the target model to determine whether the (N+1)th second electrical signal meets the target condition;
processing the (N+1)th second electrical signal based on the target model to obtain the third electrical signal.

14. The electronic device of claim 13, wherein processing N temporally consecutive second electrical signals includes:
extracting time domain features and frequency domain features of the N temporally consecutive second electrical signals; and
processing the time domain features and frequency domain features of the N second electrical signals based on the target model to determine whether the (N+1)th second electrical signal meets the target condition.

15. The electronic device of claim 13, wherein processing the (N+1)th second electrical signal includes:
processing the (N+1)th second electrical signal based on the target model and multiple second electrical signals preceding and following the (N+1)th second electrical signal to obtain the third electrical signal.

16. The electronic device of claim 13, wherein the processor is further configured to perform:
processing multiple second electrical signals before the (N+1)th second electrical signal based on the target model to obtain multiple third electrical signals; and
processing multiple second electrical signals after the (N+1)th second electrical signal based on the target model to obtain multiple third electrical signals.

17. The electronic device of claim 13, wherein processing N temporally consecutive second electrical signals includes:
processing N temporally consecutive second electrical signals based on the target model to determine that signal amplitude of the (N+1)th second electrical signal is greater than an upper limit of the signal amplitude of the acquisition device.

18. The electronic device of claim 10, wherein the target model is constructed based on a sample sound signal and a target sound signal collected from a same sound source, the sample sound signal is collected by the acquisition device, and the target sound signal is collected by a target device different from the acquisition device.

19. A non-transitory computer-readable storage medium storing computer program instructions executable by at least one processor to perform:
obtaining a first sound signal by an audio acquisition component;
transforming the first sound signal into a first electrical signal;
amplifying the first electrical signal into a second electrical signal according to a first gain value corresponding to the audio acquisition component; and
processing the second electrical signal by a target model stored in the electronic device to obtain an output electrical signal, wherein the output electrical signal includes a third electrical signal, the third electrical signal differs from the first electrical signal by a second gain value, and the second gain value is less than the first gain value.

20. The non-transitory computer-readable storage medium of claim 19, wherein processing the second electrical signal includes:
obtaining a plurality of temporally consecutive second electrical signals;
processing the plurality of second electrical signals based on the target model to obtain a plurality of output electrical signals, wherein the (i−1), (i), and (i+1)-th output electrical signals are three temporally consecutive third electrical signals;
a second gain of the (i)-th third electrical signal relative to the first electrical signal is greater than a second gain of the (i−1)-th third electrical signal relative to the first electrical signal;
the second gain of the (i)-th third electrical signal relative to the first electrical signal is greater than a second gain of the (i+1)-th third electrical signal relative to the first electrical signal.
